(19) United States
(12) Patent Application Publication
(10) Pub. No.: US 2007/0266359 A1
(43) Pub. Date: Nov. 15, 2007

(54) Relative Floorplanning For Improved Integrated Circuit Design

(75) Inventors: Henrik Esbensen, Vista, CA (US); Roger Carpenter, Palo Alto, CA (US); Cornelis Van Eijk, Hilvarenbeek (NL); Kwok-Shing Leung, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Magma Design Automation, Inc., San Jose, CA (US)

(21) Appl. No.: 11/748,416

(22) Filed: May 14, 2007

Related U.S. Application Data
(60) Provisional application No. 60/800,665, filed on May 15, 2006.

(51) Int. Cl. G06F 17/50

(52) U.S. Cl. 716/10

(57) ABSTRACT

A method for designing integrated circuits includes receiving a floorplan design associated with an integrated circuit. A relative floorplanning constraint is extracted from the floorplan design. The floorplan of the integrated circuit is updated in response to the relative floorplanning constraint. Another method for designing integrated circuits includes receiving a floorplan design associated with an integrated circuit. A set of relative floorplanning constraint is received from the floorplan design. A relative floorplanning constraint is pushed down from the set of relative floorplanning constraints into a partition associated with the floorplan of the integrated circuit. The floorplan is updated in response to the set of relative floorplanning constraints.

### CROSS-REFERENCES TO RELATED APPLICATIONS

This application claims the benefit of and priority to U.S. Provisional Application No. 60/800,665, filed May 15, 2006 and entitled “Relative Floorplanning for Improved Integrated Circuit Design,” the entire disclosure of which is hereby incorporated by reference for all purposes.

### BACKGROUND OF THE INVENTION

The present invention relates to electronic design automation (EDA) of integrated circuits. More specifically, the present invention relates to techniques for relative floorplanning of a physical design for an integrated circuit chip.

The process of generating a physical design for an integrated circuit chip is complicated. The physical design represents the layout of the integrated circuit chip on a semiconductor, such as silicon, and is utilized to fabricate the integrated circuit chip. There are multiple types of physical designs including: flat physical designs and hierarchical physical designs. Typically, the physical design is generated in several stages. Examples of these stages include floorplanning, placement, routing, and verification. In a flat physical design, these stages are sequentially performed on the entire layout, while in a hierarchical physical design these stages are sequentially performed on partitions of the layout referred to as blocks (or place-and-route blocks).

Floorplan design is an important step in the physical design of integrated circuits to plan the positions of a set of circuit modules on a chip in order to optimize the circuit performance. In general, it is common that a designer will want to control the positions in the floorplanning step of some modules in the final packing for various reasons. For example, a designer may want to restrict the separation between two modules if there are many interconnections between them, or the designer may want to align them vertically in the middle of the chip for bus-based routing. In addition, in design re-use, the designer may want to keep the positions of some modules unchanged in a new floorplan. However, an effective method to control the absolute or relative positions of the modules in floorplanning is non-trivial and this inadequacy has limited the application and usefulness of many floorplanning algorithms in practice.

Moreover, floorplanning is typically performed before placement and routing. Thus, floorplanning affects subsequent stages such as placement and routing. The main goal and objective of floorplanning is creating a floorplan, which can determine whether placement and routing are possible for the physical design.

These stages or steps of designing a chip are generally iterative. Most chips need to go through the complete design process, starting with a description, for example, in RTL (Register Transfer Language) and resulting with a layout, for example, in GDSII (Graphic Design System II), many times. During each iterative pass through the design process, there may be an improvement in the appropriate floorplanning placement of the various on-chip structures (e.g., placement of partition boundaries, and placement hard and soft macros). Unfortunately, each pass through the design process takes a significant amount of design effort and processing time.

Accordingly, what is desired are improved methods and apparatus for solving some of the problems discussed above, while reducing further drawbacks, some of which are discussed above.

### BRIEF SUMMARY OF THE INVENTION

The present invention relates to electronic design automation (EDA) of integrated circuits. In short, the present invention relates to techniques for automated design of an integrated circuit based on relative floorplanning constraints.

In various embodiments, a method for designing integrated circuits includes receiving a floorplan design associated with an integrated circuit. A first relative floorplanning constraint is extracted from the floorplan design. The floorplan of the integrated circuit is then updated in response to the first relative floorplanning constraint.

In some embodiments, a second relative floorplanning constraint is received. The floorplan of the integrated circuit is then updated in response to the second relative floorplanning constraint. The second relative floorplanning constraint may be modified based on the first relative floorplanning constraint. The floorplan of the integrated circuit may be updated in response to the modified second relative floorplanning constraint.

In one embodiment, a type is identified associated with the first relative floorplanning constraint. A constraint type can include, but is not limited to, horizontal location constraints, vertical location constraints, sizing constraints, width-to-width sizing constraints, height-to-height sizing constraints, and rotational constraints. A constraint graph is generated based on the type. An edge between a first node and a second node of the graph may represent a relative floorplanning constraint between a first object and a second object. In some embodiments, the integrity of the first relative floorplanning constraint is determined.

In a further method for designing integrated circuits, the method includes receiving a floorplan design associated with an integrated circuit. A set of relative floorplanning constraints is received from the floorplan design. A relative floorplanning constraint is pushed down from the set of relative floorplanning constraints into a partition associated with the floorplan of the integrated circuit. The floorplan is then updated in response to the set of relative floorplanning constraints.

In some embodiments, floorplanning is performed on the partition into which the relative floorplanning constraint was pushed down. Pushing down the relative floorplanning constraint may include identifying a relative floorplanning constraint that crosses one or more partition boundaries. The relative floorplanning constraint may be segmented into at least a first constraint and a second constraint. The first constraint is associated with a first partition boundary and the second constraint is associated with a second partition boundary. The relative floorplanning constraint may relate to a location of an object. The relative floorplanning constraint may relate to rotation of an object. The relative floorplanning constraint may relate to sizing of an object.

In some embodiments, a computer program product is stored on a computer readable medium for designing integrated circuits. The computer program product includes code for receiving a floorplan design associated with an integrated circuit, code for extracting a first relative floorplanning constraint from the floorplan design, and code for updating the floorplan of the integrated circuit in response to the first relative floorplanning constraint.

In various embodiments, a computer program product stored on a computer readable medium for designing integrated circuits includes code for receiving a floorplan design associated with an integrated circuit, code for receiving a set of relative floorplanning constraints from the floorplan design, code for pushing down a relative floorplanning constraint from the set of relative floorplanning constraints into a partition associated with the floorplan of the integrated circuit, and code for updating the floorplan in response to the set of relative floorplanning constraints.

In one embodiment, a system for designing integrated circuits includes a processor and a memory. The memory is coupled to the processor and configured to store a plurality of code modules which when executed by the processor cause the processor to receive a floorplan design associated with an integrated circuit, extract a first relative floorplanning constraint from the floorplan design, and update the floorplan of the integrated circuit in response to the first relative floorplanning constraint.

In further embodiments, a system for designing integrated circuits includes a processor and a memory coupled to the processor. The memory stores a plurality of code modules which when executed by the processor cause the processor to receive a floorplan design associated with an integrated circuit; receive a set of relative floorplanning constraints from the floorplan design; push down a relative floorplanning constraint from the set of relative floorplanning constraints into a partition associated with the floorplan of the integrated circuit, and update the floorplan in response to the set of relative floorplanning constraints.

A further understanding of the nature and the advantages of the inventions disclosed herein may be realized by reference of the remaining portions of the specification and the attached drawings.

### BRIEF DESCRIPTION OF THE DRAWINGS

In order to more fully understand the present invention, reference is made to the accompanying drawings. Understanding that these drawings are not to be considered limitations in the scope of the invention, the presently described embodiments and the presently understood best mode of the invention are described with additional detail through use of the accompanying drawings.

FIG. 1 is a block diagram of a user interface model for designing an integrated circuit using relative floorplanning constraints in one embodiment according to the present invention;

FIG. 2 is a block diagram of interactions during electronic design automation using relative floorplanning constraints in one embodiment according to the present invention;

FIG. 3 is a simplified flowchart of a method for optimizing a physical layout of an integrated circuit using relative floorplanning constraints in one embodiment according to the present invention;

FIG. 4 is a flowchart of a method for partitioning relative floorplanning constraints for reference to boundaries of physical partitions associated with an integrated circuit in one embodiment according to the present invention;

FIGS. 5A and 5B are block diagrams of before and after push down of relative floorplanning constraints in one embodiment according to the present invention;

FIG. 6 is a flowchart of a method for extracting relative floorplanning constraints in one embodiment according to the present invention;

FIGS. 7A and 7B are graphs depicting extraction of relative floorplanning constraints in one embodiment according to the present invention;

FIGS. 8A and 8B are block diagrams illustrating objects and associated location-based relative floorplanning constraints in one embodiment according to the present invention;

FIG. 9 is a block diagram illustrating an object and another example of location-based relative floorplanning constraints in one embodiment according to the present invention;

FIGS. 10A and 10B are block diagrams illustrating objects and associated size-based relative floorplanning constraints in one embodiment according to the present invention;

FIG. 11 is a block diagram illustrating objects and rotation-based relative floorplanning constraints in one embodiment according to the present invention;

FIGS. 12A, 12B, 12C, and 12D are block diagrams illustrating labeling of object sides/edges in one embodiment according to the present invention;

FIG. 13 is a screenshot of a graphical user interface (GUI) for editing and creating relative floorplanning constraints in one embodiment according to the present invention; and

FIG. 14 is a simplified block diagram of a computer system that may incorporate embodiments of the present invention.

### DETAILED DESCRIPTION OF THE INVENTION

The present invention relates to electronic design automation (EDA) of integrated circuits. More specifically, the present invention relates to techniques for relative floorplanning of a physical design for an integrated circuit chip.

In various embodiments, methods and apparatus for automated design of an integrated circuit using relative floorplanning are disclosed. In general, a floorplan design is a high-level layout of modules that are implemented on an integrated circuit. The floorplan design typically includes constraints that define how the modules can be laid out relative to other modules. For example, two modules may need to be placed within a certain distance of each other in order to meet timing requirements. Each constraint may define relative locations, relative dimensions, or relative rotations of a pair of objects.

During the top-level floorplan design stage of a hierarchical physical design, blocks are arranged on a selected chip area and chip shape. In arranging the blocks, individual blocks are sized and shaped. These blocks can have any number of cells that execute digital or analog functions (e.g., NAND, NOR, D flip-flop, etc.) by connectively grouping circuit elements such as transistors, capacitors, resistors, and other circuit elements. Moreover, these blocks can have one or more macrocells. A macrocell is a functional module such as RAM, ROM, ALU, etc. Each of these cells and macrocells has one or more ports (or terminals) for inputting signals or outputting signals, each of which, in turn, may connect to one or more ports of other cells and macrocells via metal wires. A net is a set of two or more ports that are connected. Generally, the input to the floorplanning stage is a netlist for the integrated circuit chip. A netlist is a list of nets for the integrated circuit chip.

Also during the top-level floorplanning stage, the locations of Input/Output blocks are determined. In general, these Input/Output blocks facilitate connections/communication with external components. An Input/Output block may have bonding pad cells or bump cells. Moreover, power distribution and clock distribution are determined during the top-level floorplanning stage of the hierarchical physical design. Furthermore, the top-level floorplanning stage is performed with the objectives of minimizing the chip area and minimizing delay.

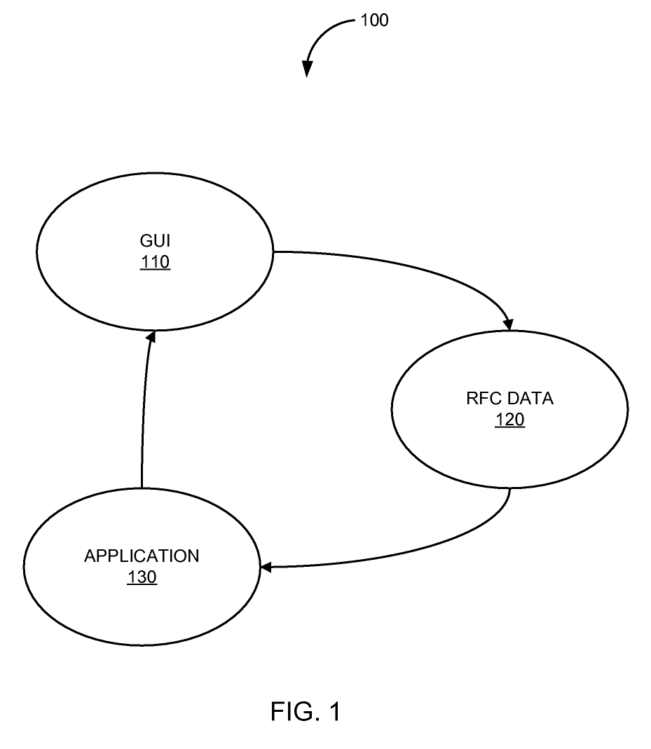

FIG. 1 is a block diagram of a user interface model 100 for designing an integrated circuit using relative floorplanning constraints in one embodiment according to the present invention. User interface model 100 includes a graphical user interface (GUI) 110, relative floorplanning constraint (RFC) data 120, and an application 130. In this example, a user interacting with GUI 110 creates, enters, imports, and/or edits information specifying the relative floorplanning of an integrated circuit. The information (e.g., one or more relative floorplanning constraints) is stored as RFC data 120.

RFC data 120 provides a data model for one or more relative floorplanning constraints associated with the integrated circuit. A constraint is any relationship between an object and a reference. The reference may be another object, position, and the like. The relationship may define relative location, size, orientation of the object, and the like. Constraints can be applied to objects that are soft macros, hard macros, pads, floorplans, regions, placement blockages, routing blockages, flyovers, and feedthroughs. Some examples of constraints include location constraints, alignment constraints, sizing constraints, rotation constraints, and the like. A location constraint is any constraint related to position of an object. A location constraint may be related to one or more dimensions. Furthermore, a location constraint may be related to alignment. In another example, a sizing constraint is any constraint related to size of an object. A size constraint may be related to height and/or width of an object, such as rectangular object. In yet another example, a rotation constraint is any constraint related to orientation of an object.

In various embodiments, each of the constraint types are equalities that are non-directional. In other words, a constraint between objects A and B does not define whether object A or object B is modified to meet the constraint.

Application 130 attempts to honor each of the constraints contained in RFC data 120 as input. For example, application 130 may include a partitioning application, a macro placement application, a block shaping application, a channel sizing application, and the like. In various embodiments, application 130 does not add or edit constraints, except to maintain constraint integrity.

The user then may use again GUI 110 to evaluate the results of application 130. The user then may decide whether to add (e.g., extract) or edit one or more constraints in RFC data 120. These stages or steps of designing a chip are generally iterative. Thus, the user iterates through user interface model 100 various times to improve the floorplanning placement of various on-chip structures.

In various embodiments, user interface model 100 enables one or more relative floorplanning constraints which are originally described with respect to a floorplan and a given physical hierarchical level design to be pushed down to be described with respect to partition boundaries. For example, a constraint which crosses one or more physical partition boundaries can be segmented along those boundaries. Accordingly, each segment may be described by how the segment relates to a boundary line. Thus, user interface model 100 enables constraint push down such that each relative constraint continues to belong to a single physical hierarchal level, thereby enabling implementation of the block without introducing dependencies on other physical hierarchal levels.

In some embodiments, user interface model 100 enables relative constraints to be extracted from a floorplan design. In one example, a constraint extractor examines selected objects in order to describe their relationship using constraints. A user then may make changes to the floorplan design, and in response, user interface model 100 updates the constraints. Some examples of objects that may be considered include pads, soft macros, hard macros, blockages, flyovers, and feedthroughs. The distance, relative dimensions, or relative rotations between any object, whether the same type of object or not, can be the target of a relative floorplanning constraint.

In still further embodiments, user interface model 100 enables hard and soft constraints to be utilized in relative floorplanning. Hard constraints are any requirements that must be absolutely met. Soft constraints are any requirements that may or may not be met. Ideally, soft constraints are met but if they are not exactly met, a penalty function is applied. The farther that a soft constraint is from being met, the greater the output of the resulting penalty function. Typically, in an optimal design, all hard constraints are fully met, many soft constraints will also be fully met, and the remaining soft constraints will be close to being met. This condition typically results in only a small total when the outputs of all the penalty functions are summed.

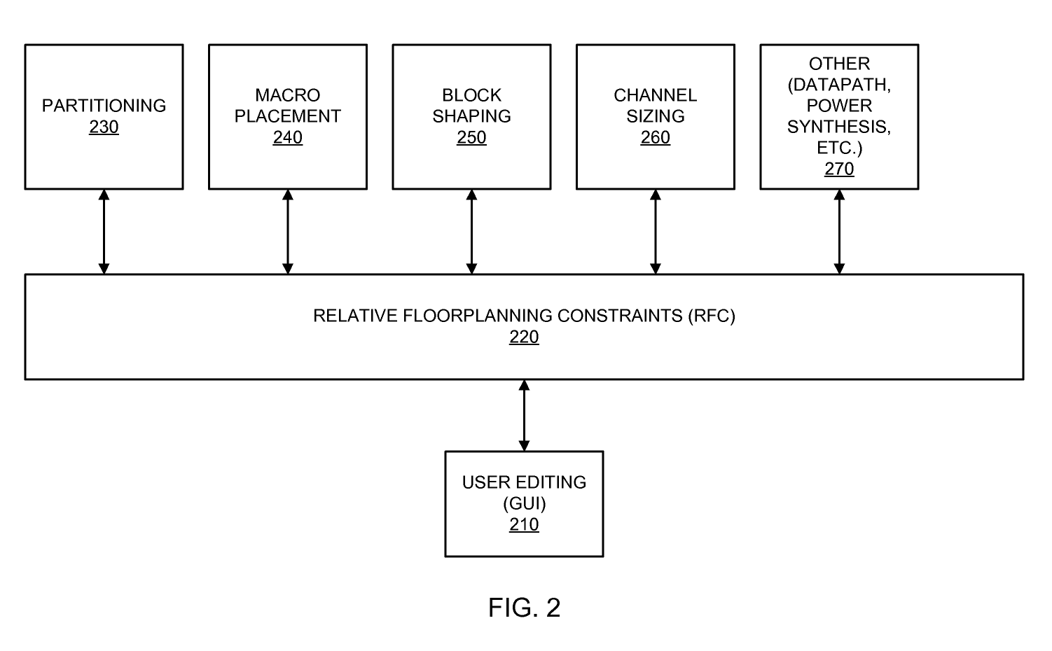

FIG. 2 is a block diagram of interactions during electronic design automation using relative floorplanning constraints in one embodiment according to the present invention.

In this example, during user editing 210, a user interacts with a graphical user interface (GUI) to create, import, define, and/or edit relative floorplanning constraints (RFC) 220. RFC 220 represents the current “good” parts of the design. RFC 220 may gradually be expanded and refined throughout the interactions during the electronic design automation process.

For example, RFC 220 may be gradually expanded and refined during various stages of design of an integrated circuit, including for example, during partitioning 230, macro placement 240, block shaping 250, channel sizing 260, and other stages 270 (e.g., datapath, power synthesis, and the like).

Typically, descriptions of large integrated circuits are generally hierarchical. The hierarchical structure of the input RTL code or gate-level netlist constitutes a logical hierarchy. In contrast, the physical hierarchy is the hierarchical structure used to physically implement the circuit. Each physical level is often referred to as a block, or a (hard or soft) macro. New physical hierarchy levels are created during partitioning 230. Each block (partition) can be implemented separately, by different chip designers, in parallel.

Since relative floorplanning constraints describe relationships between physical objects, the constraints naturally belong in the domain of the physical hierarchy. Specifically, any relative floorplanning constraint belongs to a single specific physical block. This ensures that during implementation of a given block, all relative floorplanning constraints are available within that block itself (i.e., the relative constraints of that block are self-contained and do not depend on any relative constraints which may exist at other physical hierarchal levels).

Throughout the floorplanning process, in various embodiments, the integrity (validity, legality) of existing relative constraints is enforced. Each constraint needs to be valid when considered in isolation. For example, the two objects associated with a constraint need to exist and need to be constrainable. Furthermore, the set of constraints and a model need to be valid as a whole. In one example, cyclical constraints (a sequence of constraints forming a loop, with the last object in the sequence being constrained to the first) are typically invalid because such constraints do not have a solution.

Furthermore, throughout the floorplanning process, constraints are automatically updated to maintain constraint integrity as various operations are performed. In one example, when a constrained object is deleted, all constraints associated with the deleted object are also deleted automatically. In another example, during partitioning 230, when a new physical hierarchy is introduced, constraints are budgeted and split along partitioning boundaries. Similarly, when a physical hierarchy is eliminated, for example by undoing a partitioning operation or by explicitly deleting a physical hierarchy level, constraints are automatically preserved and moved up to the next physical hierarchy level.

In addition to the automatic maintenance of constraint integrity, a user may be able to verify the integrity of all constraints at any point in time. Accordingly, the user may manually add constraints that are not valid in the context of pre-existing constraints.

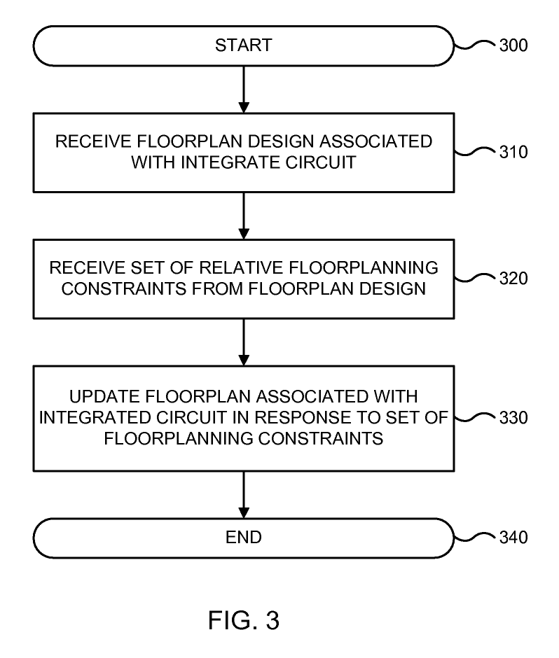

FIG. 3 is a simplified flowchart of a method for optimizing a physical layout of an integrated circuit using relative floorplanning constraints in one embodiment according to the present invention. The processing depicted in FIG. 3 may be performed by software modules (e.g., instructions or code) executed by a processor of a computer system, by hardware modules of the computer system, or combinations thereof. FIG. 3 begins in step 300.

In step 310, a floorplan design associated with an integrated circuit is received. For example, a floorplan design may be imported into an electronic design automation (EDA) application. In general, the floorplan design is a high-level layout of modules that are implemented on an integrated circuit.

In step 320, a set of relative floorplanning constraints is received based on the floorplan design. For example, one or more pre-existing relative floorplanning constraints may be determined or extracted from the floorplan design. In another example, a set of relative floorplanning constraints may be received from a user interacting with a graphical user interface associated with a relative floorplanning application.

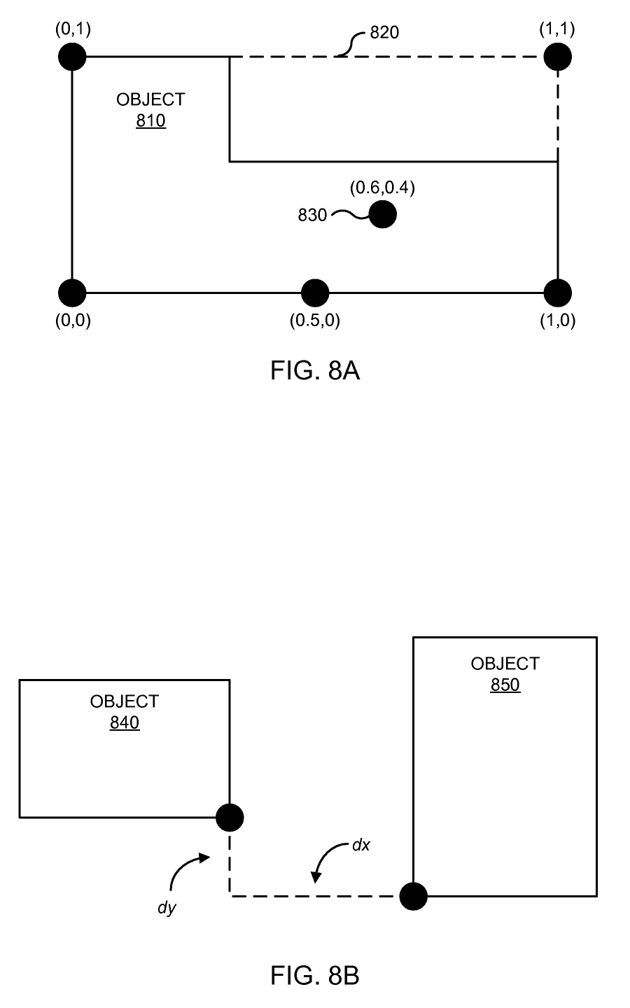

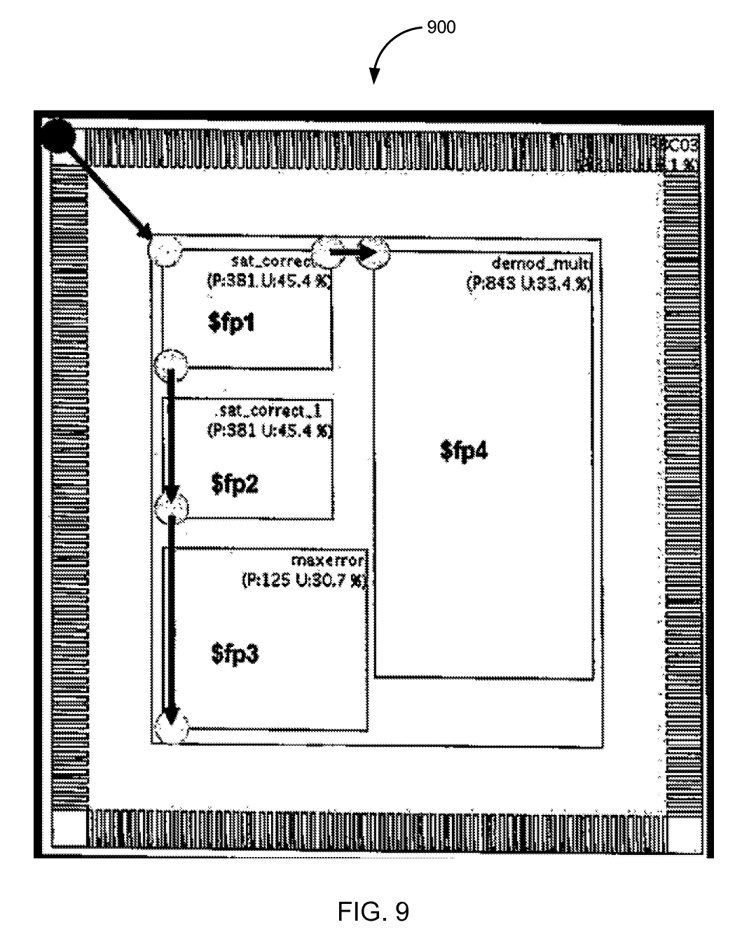

As discussed previously, constraints can be applied to objects that are soft macros, hard macros, pads, floorplans, regions, placement blockages, routing blockages, flyovers, and feedthroughs. Some examples of constraints include location constraints, including special cases of alignment, sizing, and rotation. A location constraint is any constraint related to position of an object. A location constraint may be related to one or more dimensions. Furthermore, a location constraint may be related to alignment. Some examples of location constraints are discussed further with respect to FIGS. 8A, 8B and 9.

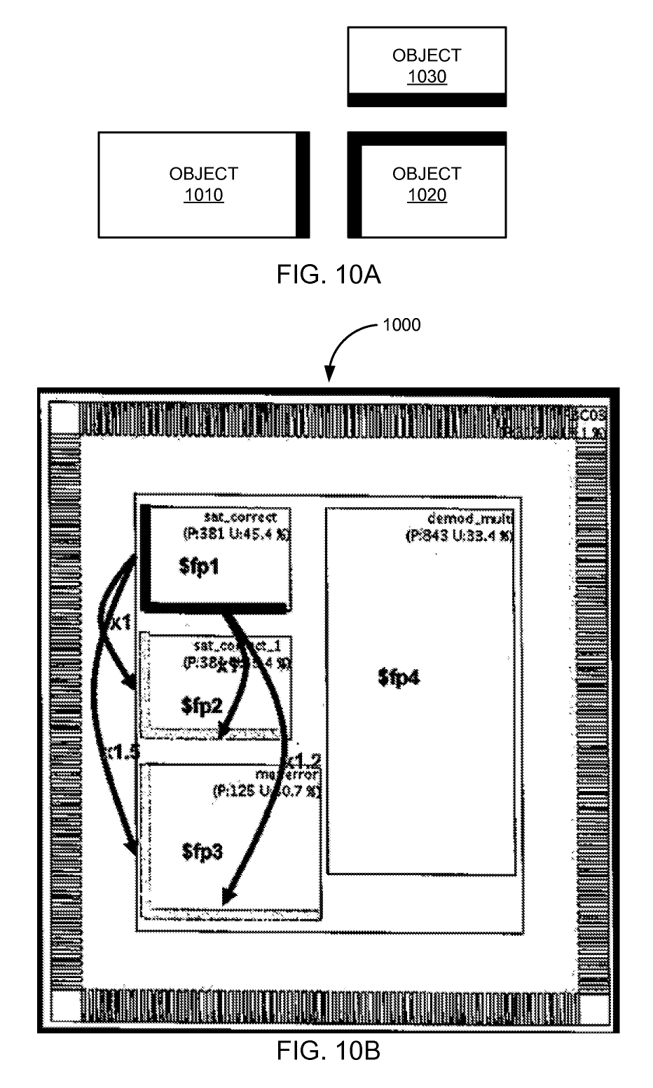

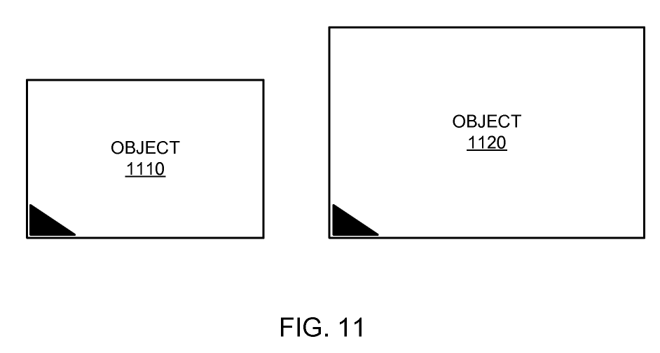

In another example, a sizing constraint is any constraint related to size of an object. A size constraint may be related to height and/or width of an object, such as rectangular object. Some examples of sizing constraints are discussed further with respect to FIGS. 10A and 10B. In yet another example, a rotation constraint any constraint related to orientation of an object. Generally, a rotation constraint is related to a macro. One example of a rotation constraint is described further with respect to FIG. 11.

In various embodiments, each of the constraint types are equalities that are non-directional. In other words, a constraint between objects A and B does not define whether object A or object B is modified to meet the constraint.

Referring again to FIG. 3, in step 330, the floorplan associated with the integrated circuit is updated in response to the set of floorplanning constraints. For example, one or more physical partitions are created in the floorplan. Partitioning may generate multiple soft macros, which may in turn have smaller hard macros inside themselves. The resulting partitions can then be reshaped or in other ways manipulated to improve the chip design.

In various embodiments, before the physical partitions are created, a constraint solver may solve for one or more constraints associated with components that contain constraints that cross boundaries of the physical partitions. In one embodiment, constraints may be extracted from the floorplan.

In some embodiments, constraints may be segmented relative to position in the floorplan design. For example, a single constraint in a pre-partition stage may be represented by three constraints in a post-partition stage. The resulting constraints are associated with corresponding physical partitions. More specifically, these relative floorplanning constraints are pushed down into the partitions to enable independent implementation of each partition.

In one embodiment, the constraint solver operates on a given set of constraints. The constraint solver first divides the constraints into four groups by constraint type: rotation constraints, sizing constraints, horizontal location constraints and vertical location constraints. Each constraint in the latter two categories is either an alignment constraint (a 1-dimensional location constraint) or it is one dimension of a 2-dimensional location constraint. The constraint groups are considered in the fixed order mentioned above. For each constraint group, a topological sort is performed of all edges in that group. If (a subset of) the edges form a cycle or constitute a path between two objects which are fixed with respect to the given constraint type (for example, rotation), then no feasible solution exists and the constraint solver fails. Otherwise, it executes (enforces) each constraint in the group in the order determined by the topological sort. Since all constraints are equalities, no criteria are optimized. Executing a constraint simply means rotating, resizing and moving objects in the layout so that the constraint is satisfied. FIG. 3 ends in step 340.

In various embodiments, one or more relative floorplanning constraints in the set of floorplanning constraints may be segmented relative to a position in the floorplan design. The segmented constraints then are pushed down for reference to the boundaries within the physical layout. The newly segmented constraints are then added to the set of relative floorplanning constraints, possibly replacing the previous un-segmented constraint.

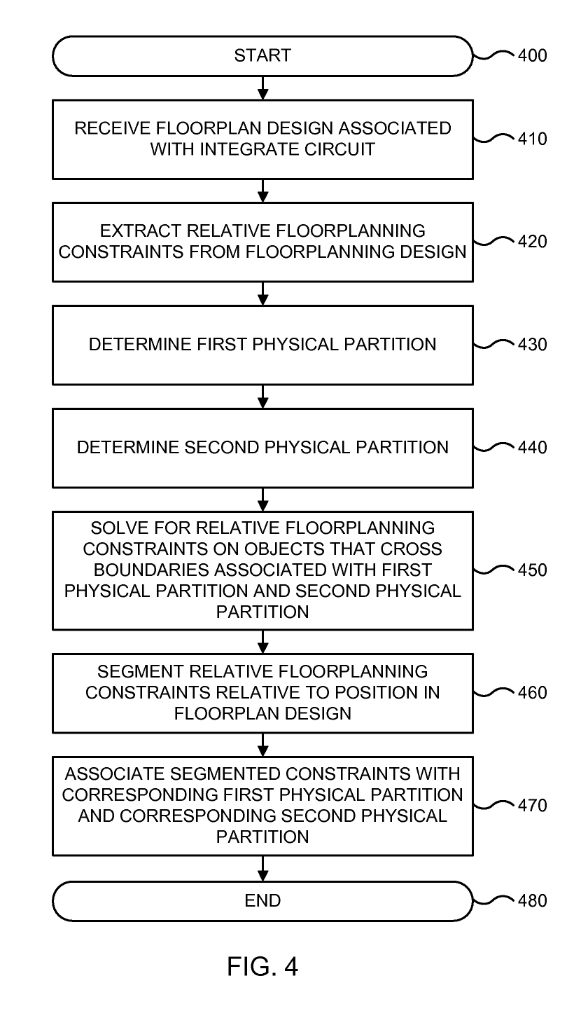

FIG. 4 is a flowchart for partitioning relative floorplanning constraints for reference to boundaries of physical partitions associated with an integrated circuit in one embodiment according to the present invention. FIG. 4 begins in step 400.

In step 410, a floorplan design associated with an integrated circuit is received. In step 420, one or more relative floorplanning constraints are extracted from the floorplan design.

In step 430, a first physical partition is determined. In step 440, a second physical partition is determined. In step 450, constraints on objects are solved to cross boundaries associated with the first physical partition and the second physical partition. Note that while two physical partitions are discussed in this example, any number of partitions may be determined. Additionally, the partitions may be determined at this point or they may be pre-existing and known in the design. Typically, the number of partitions may depend on the design size, and like factors. Then the constraints, which intersect one or more of the partition boundaries, may be solved for (or budgeted).

In step 460, one or more constraints are segmented relative to position in the floorplan. In step 470, the segmented constraints are associated with the corresponding first physical partition and the corresponding second physical partition. FIG. 4 ends in step 480.

In various embodiments, a constraint graph is generated for a given constraint type. A constraint solver performs a topological sort of all components (edges) in the graph. The resulting ordered list of the constraints has the property that any given constraint in the list only depends (recursively) on constraints occurring earlier in the list. The constraint solver then traverses the ordered list in ascending order, executing all constraints in the graph, so that upon completion, each constraint is met in the current physical design.

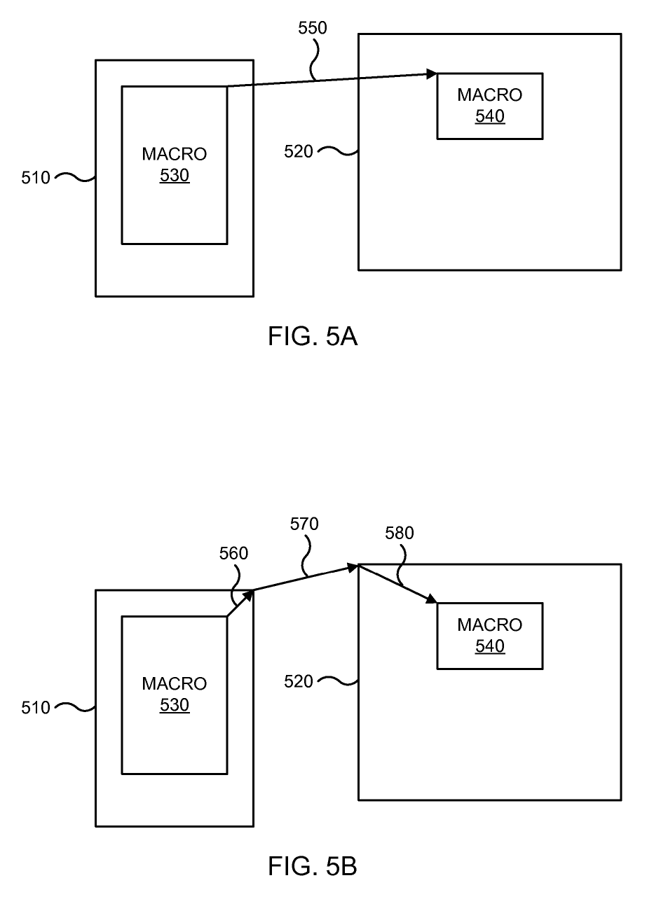

FIGS. 5A and 5B are block diagrams of before and after push down of relative floorplanning constraints in one embodiment according to the present invention. FIG. 5A includes a partition 510 and a partition 520. Partition 510 includes a macro 530. Partition 520 includes a macro 540. A relative floorplanning constraint 550 is associated with the top right hand corner of macro 530 in the top left-hand corner of macro 540.

In this example, a single constraint 550 (the simplest possible situation, a constraint component consisting of just one constraint) is shown between macro 530 and macro 540, belonging to two different partitions 510 and 520. In various embodiments, a constraint solver is first run to ensure that the actual physical distance matches the constraint value. In one example, the constraint may be a one-dimensional horizontal location constraint that specifies 100 microns between macro 530 and 540.

However, the current physical distance between macro 530 and macro 540 may be any other number. Having executed the constraints over, it may be known that the actual physical distance between macro 530 and macro 540 is also 100 microns. Now, 100 microns is examined for how it is actually distributed in the physical layout to determine the floorplan constraint budget. In one example, the distribution of 100 microns includes 30 microns inside partition 510, 50 microns between partitions 510 and 520, and 20 microns inside partition 520. The original constraint 550 is then deleted, and a new constraint is added to the partitions.

Referring to FIG. 5B, relative floorplanning constraint 550 is pushed down into a relative floorplanning constraint 560, a relative floorplanning constraint 570, and the relative floorplanning constraint 580. In this example, constraint 560 is associated with the top right-hand corner of macro 530 and the top right-hand corner of partition 510. Constraint 570 is associated with the top right-hand corner of partition 510 and the top left-hand corner of partition 520. Constraint 580 is associated with the top left-hand corner of partition 520 in the top left-hand corner of macro 540.

In this example, a 30-micron constraint (e.g., constraint 560) is added between macro 530 and partition 510. In various embodiments, a soft macro may be created to represent partition 510. Thus, the 30-micron constraint is added between macro 530 and the soft macro representing partition 510. Similarly, a 20-micron constraint (e.g., constraint 570) is associated with a soft macro created to represent partition 520. At the top level, a 50-micron constraint (e.g., constraint 560) is created between the soft macro representing partition 510 and the soft macro representing partition 520. In some embodiments, additional constraints can be pushed down from the floorplan designed to the partition level.

Thus, constraint 550, which crosses physical partition boundaries, can be segmented into further constraints associated with the boundary lines. Accordingly, each constraint 560, 570, and 580 are described by how the constraint relates to a boundary line. Constraints 560, 570, and 580 can be considered segment portions, which combined, make up relative floorplanning constraint 550. Thus, constraints may be pushed down such that each relative constraint continues to belong to a single physical hierarchal level, thereby enabling implementation of the block without introducing dependencies on other physical hierarchal levels.

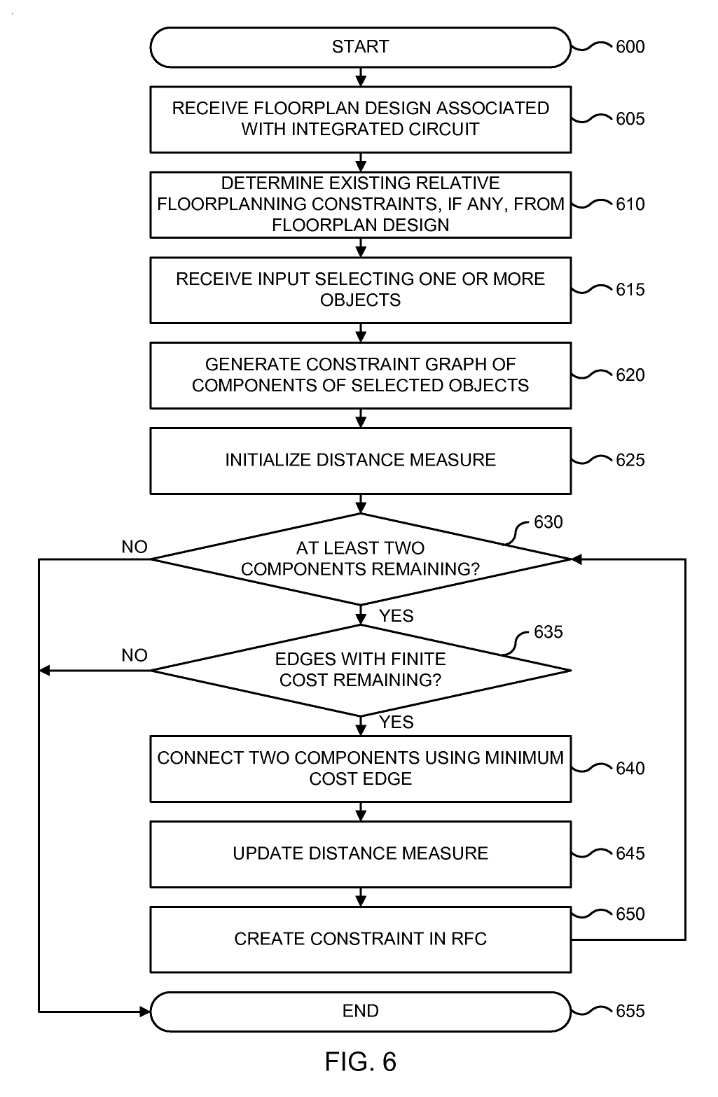

FIG. 6 is a flowchart for extracting relative floorplanning constraints in one embodiment according to the present invention. FIG. 6 begins in step 600.

In step 605, a floorplan design associated with an integrated circuit is received. In step 610, existing relative floorplanning constraints are determined, if any, from the floorplan design. For example, previously existing relative floorplanning constraints may be extracted from the floorplan design. Additionally, relative floorplanning constraints previously provided by a user may be imported.

In step 615, input is received selecting one or more objects associated with the floorplan design. In general, the floorplan design can have two or more selected objects. The floorplan design may also have pre-existing relative constraint. For example, a user interacting with the graphic user interface may select soft macros, hard macros, pads, floorplans, regions, placement blockages, routing blockages, flyovers, feedthroughs, and the like.

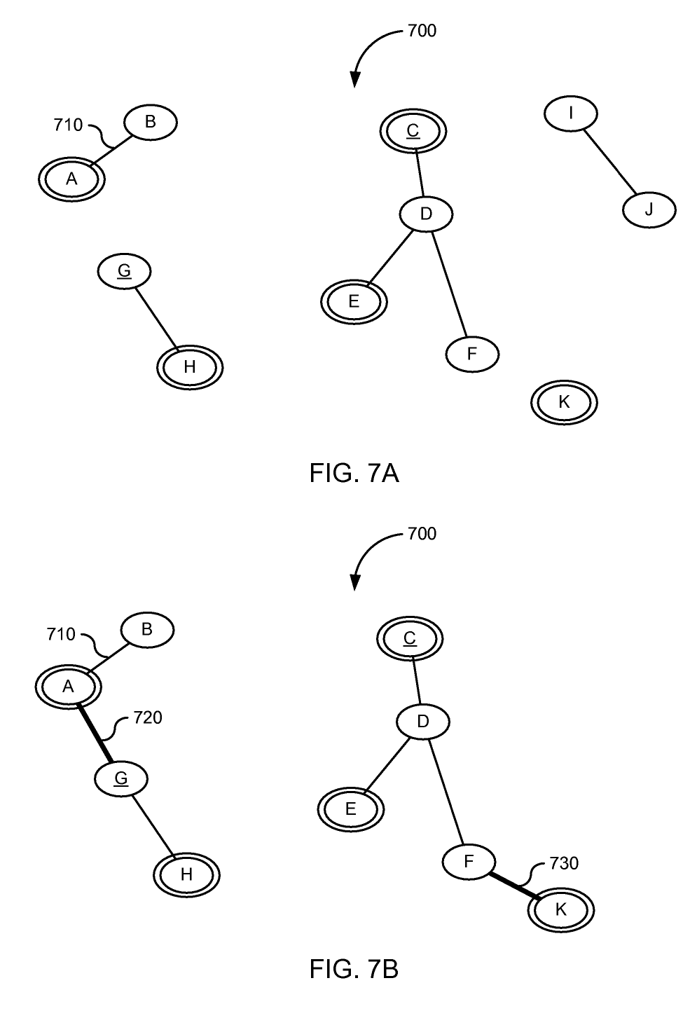

In step 620, a constraint graph is generated of components of the selected objects. One example of a constraint graph is described further with respect to FIGS. 7A and 7B.

In various embodiments, constraints may include horizontal location constraints, vertical location constraints, sizing constraints, width-to-width sizing constraints, height-to-height sizing constraints, and rotational constraints. In one example, a 2-dimensional location constraint is simply the aggregate of two 1-dimensional constraints.

A constraint graph then is built for a given constraint type (e.g., horizontal location constraints, vertical location constraints, sizing constraints, which can further include width-to-width or height-to-height constraints, and rotational constraints). In various embodiments, as a user adds constraints of all possible types, four different constraint graphs are utilized. Given a specific constraint type, such as horizontal location constraints, the physical layout and the existing set of horizontal location constraints, a constraint graph is created by representing each constraint object with a node and each constraint with an edge. The constraint graph consists of a set of connected components, however, not all components may be connected.

The weight, or cost, of an edge, matches the corresponding constraint. For example, a 50-micron horizontal location constraint may be represented by an edge with a cost of 50 microns. The exact meaning of “50 microns” may be defined using a notation of reference points, such as in FIGS. 8A and 8B.

For each constraint object used in a location constraint, a reference point may be defined. In one example, a reference point is a tuple of floating point values in the range [0,1]. This defines a point relative to the bounding box of an object. For example (0,0) is the lower left corner, (1,1) is the top right, (0.5,0.5) is the center, (0.0,0.67) is two thirds up on the left-hand side, etc. The “50 microns” distances the horizontal distance between the two reference points of the two objects.

In step 625, a distance measure is initialized. A distance measure is any measure of the actual physical distance between objects. For example, the distance between two objects can be the Manhattan distance between their reference points. Objects may be fixed with respect to a given constraint type, meaning that the object cannot be modified with respect to the relevant property. For example, hard macros are fixed with respect to sizing constraints because a hard macro cannot be resized. In another example, the user may decide that a certain property of an object, for example, the location of a blockage, should be fixed (i.e., and cannot be modified). In this case, constraint paths cannot exist between two fixed objects, since such a path would be unsolvable.

Paths between fixed objects are typically avoided by design of the distance measure. The distance between objects A and B may be defined to be infinity, if the constraint component to which object A belongs contains a fixed object and the constraint component to which object B belongs contains a fix object. In some examples, the distance measure between a first object and a second object may be infinity, even though the first object and the second object may be physically proximate.

In step 630, a determination is made whether at least two components remain in the constraint graph. Based on a positive determination, in step 635, a determination is made whether edges exist with a finite cost remaining. Based on a positive determination, in step 640, two or more components are connected using minimum cost edge.

In general, the extractor works based on ascending cost order, such that the lower cost constraints are considered first. As a result, an infinite cost edge would generally not be considered. Thus, weighting is in priority of lowest weights rather than highest. A minimum cost edge is used to connect to components, and update distance measure, for example, using the Kruskal technique.

In step 645, a distance measure is then updated. In step 650, a constraint is generated. The constraint may be stored, for example, in RFC data 120 of FIG. 1. Processing then continues in step 630, where the process is again repeated if at least two components remain.

In step 630, if at least two components do not remain, alternatively, if in step 635 there are no edges with finite cost remaining, processing ends in step 655. FIG. 6 ends in step 655.

FIGS. 7A and 7B are graph 700 depicting extraction of relative floorplanning constraints in one embodiment according to the present invention. FIG. 7A illustrates pre-existing constraints in graph 700.

Graph 700 includes objects A, B, C, D, E, F, G, H, I, J, and K represented by ovals. Fixed objects are indicated by an underlining. In this example, object G and object C are fixed objects. Constraints (e.g., constraint 710) between objects A, B, C, D, E, F, G, H, I, J, and K are represented by a thin solid line. In this example, a constraint is associated with object A and object B. A constraint is associated with object C and object D. A constraint is associated with object D and object E. A constraint is associated with object D and object F. A constraint is associated with object G and object H. A constraint is associated with object I and object J. Objects selected by a user are represented by a double oval. In this example, a user has selected object A, object C, object E, object H, and object K.

FIG. 7B illustrates constraints in graph 700 after extraction. The extraction process may occur during one or more iterations using a constraint solver. In this example, pre-existing constraints are considered before adding new constraints to prevent constraint loops (or cycles). Thus, in various embodiments, creating constraints to endpoint objects which are not necessarily selected is key. Accordingly, all constraints of the components of the selected objects are updated before new constraints are added or extracted.

Thus, in this example, a new constraint 720 is associated with object A and object G. A constraint 730 is associated with object F and object K, adding an edge to graph 700. This happens even though object G and object F have not been selected by the user. Thus, a constraint solver looks at the transitive closure of all constraints of a selected object when executed.

It will be noted that two components in the floorplan cannot be connected because of the fixed objects (e.g., object G and object C). It will be also noted that object I and object J have been dropped from graph 700 since neither of the objects were selected by the user.

In this example, the added constraints are intuitively meaningful. The user may have selected objects A, C, E, H, and K because the objects have good properties relative to each other, which should be fixed. The objects are not constrained directly to each other, but to nearby objects of the same constraint components. Thus, modifying, for example, object E will now modify K when running a constraint solver to update the set of relative floorplanning constraints.

FIGS. 8A and 8B are block diagrams illustrating objects and associated location-based relative floorplanning constraints in one embodiment according to the present invention. Referring to FIG. 8A, an L-shaped object 810 is bounded by a bounding box 820. References points, as discussed above, define a point 830 relative to bounding box 820 of object 810. For example (0,0) is the lower left corner, (0,1) is the top left corner, (1,1) is the top right, (1,0) is the lower right corner, and (0.5,0.5) is the center. Point 830 is defined by (0.6,0.4).

Referring to FIG. 8B, object 840 is constrained to object 850 by a location-based constraint associated with the lower left corner of object 840 and the lower right corner of object 850. In this example, the object 840 and the object 850 are constrained by the change in location (e.g., the dy and dx) between the constrained corners. Accordingly, the constraints may be defined as Ref(<obj>,<dim>), where <obj> specified the object and <dim> specifies the dimension. Thus, Ref(B,x)=Ref(A,x)+dx and by Ref(B,y)=Ref(A,y)+dy, where dx and dy may be arbitrary constants.

FIG. 9 is a block diagram illustrating an object 900 and another example of location-based relative floorplanning constraints in one embodiment according to the present invention. In this example, object 900 includes a floorplan $fp1, a floorplan $fp2, a floorplan $fp3, and a floorplan $fp4.

In this example, floorplan $fp1 is anchored to the top left corner of object 900. Thus, the upper left corner of floorplan $fp1 is constrained within object 900 with respect to the upper left corner of object 900. The lower left corner of floorplan $fp1 is constrained with respect to the lower left corner of floorplan $fp2, such that floorplan $fp1 is located above floorplan $fp2 with their left edges constrained to be aligned. The lower left corner of floorplan $fp2 is constrained with respect to the lower left corner of floorplan $fp3, such that floorplan $fp2 is located above floorplan $fp3 with their left edges constrained to be aligned.

Accordingly, floorplan $fp1 is also constrained to be aligned with floorplan $fp3 due to the constraints with floorplan $fp2. The vertical spacing between floorplans $fp1, $fp2, and $fp3 may be fixed.

The upper right corner of floorplan $fp1 is constrained with respect to the upper left corner of floorplan $fp4, such that floorplan $fp4 is located to the left of floorplan $fp1 with their upper edges constrained to be aligned.

Accordingly, editing any one of floorplans $fp1, $fp2, $fp3, and $fp4 maintains the relations between location and alignment. Thus, the set of relative floorplanning constraints may be automatically updated during the editing and designing process. Furthermore, during a resizing of the entire object 900 the integrity of the set of relative floorplanning constraints is automatically updated to reflect the changes to the chip.

FIGS. 10A and 10B are block diagrams illustrating objects and associated size-based relative floorplanning constraints in one embodiment according to the present invention. FIG. 10A includes an object 1010, an object 1020, and an object 1030.

In general, relative floorplanning constraints related to size (e.g., sizing constraints) are typically applicable to rectangular objects. The rectangular object may be the object itself or a bounding box associated with the object. Typically, sizing constraints are referenced with respect to the width or height of the object.

In this example, the height of object 1010 is constrained to the height of object 1020. The length of object 1020 is constrained to the length of object 1030. Thus, the h(object 1020)=h(object 1010) and w(object 1020)=w(object 1030). In various embodiments, linear scaling is supported such that d₂=ad₁+β.

Referring to FIG. 10B, and object 1000 includes a floorplan $fp1, a floorplan $fp2, a floorplan $fp3, and a floorplan $fp4.

When floorplans $fp1, $fp2, and $fp3 are resized, the relative sizes are maintained. Thus, the following sizing constraints are extracted and maintained in the set of relative floorplanning constraints:
h($fp2)=h($fp1)
w($fp2)=w($fp1)
h($fp3)=1.5×h($fp1)
w($fp3)=1.2×w($fp1)

Blockages can have relative floorplanning constraints as well. In one example, a blockage may be required which is adjacent to a soft macro and run the full width or height of the soft macro. If the blockage is needed to be that same width as the soft macro, then one embodiment may include:
Size: w(blockage)=w(soft macro)
Other types of relative floorplanning constraints can exists as well, for which relative heights or widths make sense to include.

Additionally, when the blockage and/or the soft macro are moved or resized, the relative size and location are automatically maintained.

FIG. 11 is a block diagram illustrating objects and rotation-based relative floorplanning constraints in one embodiment according to the present invention. FIG. 11 includes an object 1110 and an object 1120. In this example, the orientation of the lower left-hand corner of object 1110 is constrained with this respect to the orientation of the lower left-hand corner of object 1120. Accordingly, r(<obj>) defines the rotation constraint of an object.

For example, r(object 1110)=r(object 1120)+dr, where dr defines a fixed additive rotation. Typically, one of eight possible orientations may be constrained using rotations and mirroring.

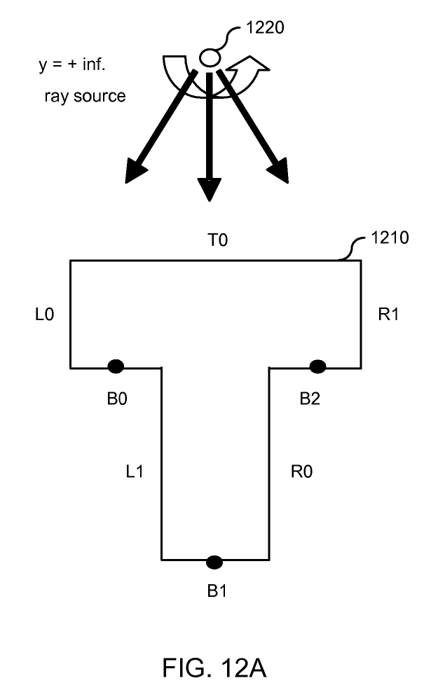

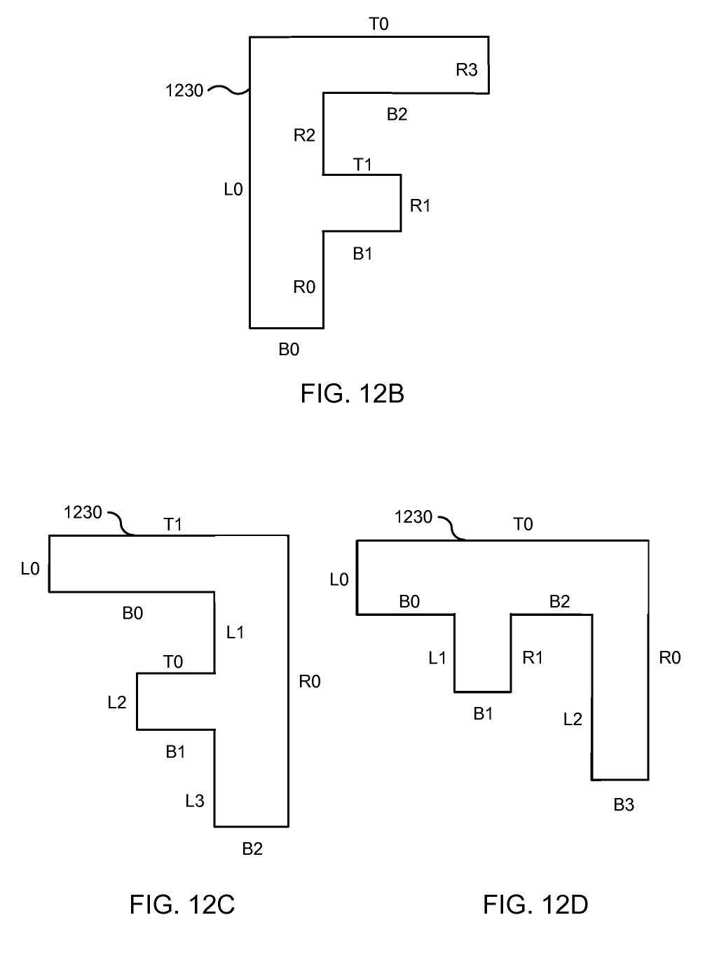

FIGS. 12A, 12B, 12C, and 12D are block diagrams illustrating labeling of object sides/edges in one embodiment according to the present invention. In various embodiments, the edges of specific objects are key, as are identification of which specific edge is of interest. Often a relative floorplanning constraint can be provided in a soft-macro edge labeling scheme which defines the distance from one specific edge of a soft macro to another specific edge of a different soft macro. In order for such a relative floorplanning constraint to operate, clearly identifying which edge is to be utilized is a requirement.

Referring to FIG. 12A, edges of a polygon 1210 are labeled as a ray from source 1220 is moved from one side of polygon 1210 to the other side in a counter-clockwise manner. Each side is labeled in the format of <side><idx>. In various embodiments, side={L, R, B, T}, where R=right face of polygon 1210, L is to the left, etc. Idx is an index number. In this example, the index number is assigned by the order in which the center point of an edge is met with the ray from source 1220.

In general, labels are relative to a context (or model). A label, for example, does not “stick” to polygon 1210, but changes when polygon 1210 is transformed. This provides an intuitive advantage in that a “Left” edge of polygon 1210 is always to the left. The context may be specified using an EDA tool using the labels. This further provides several desirable properties, such as unique labels that are intuitively meaningful (e.g., the label conveys meaning).

FIG. 12B provides an example “F” shaped object 1230. In one embodiment, the top, left, right, and bottom sides of the “F” object 1230 are labeled by an initial letter “T”, “L”, “R”, and “B” respectively. When multiple edges, on one side exist, the edges are numbered in a counter-clockwise direction. This method could be described as a soft-macro edge-labeling scheme.

FIG. 12C and FIG. 12D illustrate how the edge labels would be applied if the “F” shaped object 1230 was mirrored or rotated. Referring to FIG. 12C, during mirroring/flipping, if two sides are swapped, the index i becomes N-l-i. In this example, during a flip in the Y-axis, T and B are unchanged and L and R are exchanged, with the index becoming N-l-i. Referring to FIG. 12D, while the side changes during rotation, the index does not change. In this example, during a 90-degree clockwise rotation, T becomes R, R becomes B, B becomes L, and L becomes T, with the index remaining unchanged.

As discussed previously, location constraints may be defined as Ref(<obj>,<dim>). In various embodiments, context may be specified using the labels, such as {<label>[0,1]} For example, “T2 0.7” provides a reference to an object constraint at the T2 edge of a polygon (e.g., a macro) where 0.7 is the normalized distance along the edge T2, 0.0 being the left endpoint and 1.0 being the right endpoint.

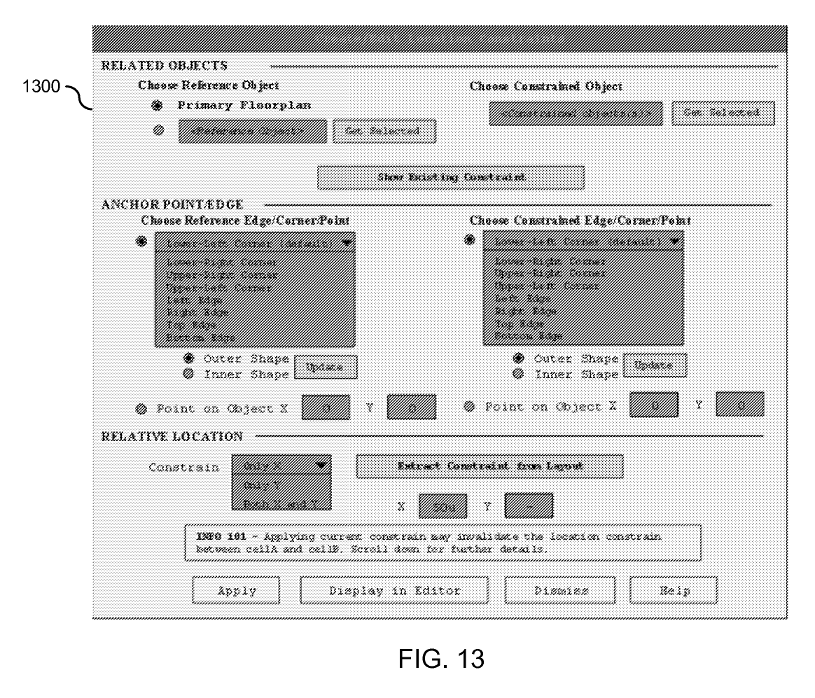

FIG. 13 is a screenshot of a graphical user interface (GUI) 1300 for editing and creating relative floorplanning constraints in one embodiment according to the present invention. In this example, GUI 1300 includes a section for choosing a reference object and a section for choosing a constrained object. GUI 1300 further includes a section for defining anchor points or edges associated with the reference object and the constrained object. GUI 1300 also includes a section for defining relative location constraints associated with the reference object and the constrained object. GUI 1300 may also include one or more buttons for interacting with the user, such as receiving text, displaying text, receiving numbers, displaying numbers, radio boxes, checkboxes, and command buttons. It should be further understood that embodiments can exist where there are distinctions between objects and references but there can equally well be embodiments where constraints are non-directional and therefore there is no distinction between objects and references. A GUI could equally well crafted to support each case.

In some embodiments, a user can generate hard or soft constraints through GUI 1300 or through a command-line interface. A hard constraint must be met explicitly. A soft constraint defines a target which is given but may be violated. Any violation has a penalty function which the constraint solver tries to minimize. The soft constraint provides more freedom for the relative floorplanning application during optimization (or layout).

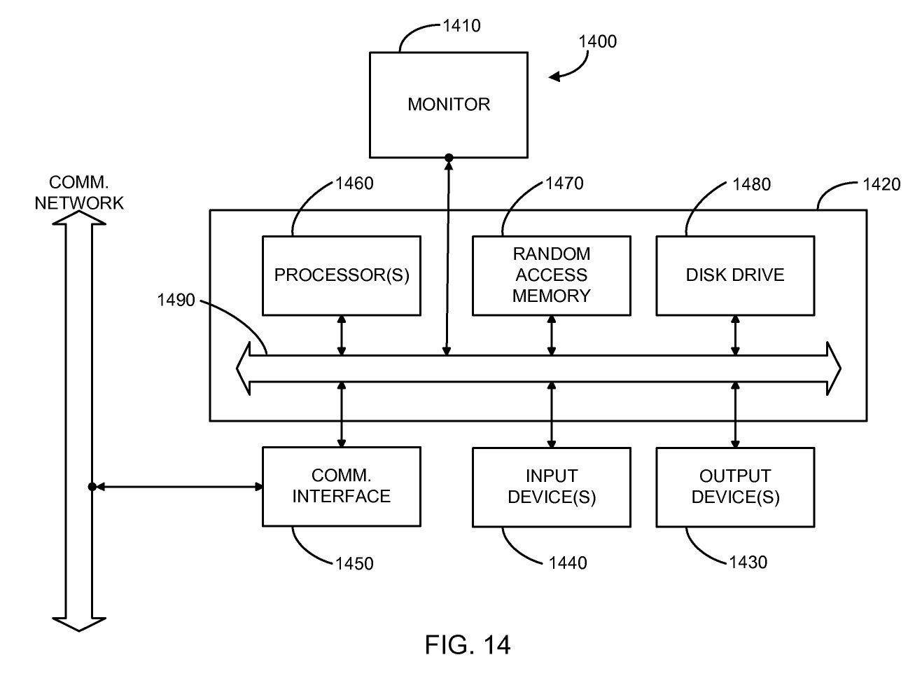

FIG. 14 is a simplified block diagram of a computer system 1400 that may incorporate embodiments of the present invention. FIG. 14 is merely illustrative of an embodiment incorporating the present invention and does not limit the scope of the invention as recited in the claims. One of ordinary skill in the art would recognize other variations, modifications, and alternatives.

In one embodiment, computer system 1400 typically includes a monitor 1410, a computer 1420, user output devices 1430, user input devices 1440, communications interface 1450, and the like.

As shown in FIG. 14, computer 1420 may include a processor(s) 1460 that communicates with a number of peripheral devices via a bus subsystem 1490. These peripheral devices may include user output devices 1430, user input devices 1440, communications interface 1450, and a storage subsystem, such as random access memory (RAM) 1470 and disk drive 1480.

User input devices 1430 include all possible types of devices and mechanisms for inputting information to computer system 1420. These may include a keyboard, a keypad, a touch screen incorporated into the display, audio input devices such as voice recognition systems, microphones, and other types of input devices. In various embodiments, user input devices 1430 are typically embodied as a computer mouse, a trackball, a track pad, a joystick, wireless remote, drawing tablet, voice command system, eye tracking system, and the like. User input devices 1430 typically allow a user to select objects, icons, text and the like that appear on the monitor 1410 via a command such as a click of a button or the like.

User output devices 1440 include all possible types of devices and mechanisms for outputting information from computer 1420. These may include a display (e.g., monitor 1410), non-visual displays such as audio output devices, etc.

Communications interface 1450 provides an interface to other communication networks and devices. Communications interface 1450 may serve as an interface for receiving data from and transmitting data to other systems. Embodiments of communications interface 1450 typically include an Ethernet card, a modem (telephone, satellite, cable, ISDN), (asynchronous) digital subscriber line (DSL) unit, FireWire interface, USB interface, and the like. For example, communications interface 1450 may be coupled to a computer network, to a FireWire bus, or the like. In other embodiments, communications interfaces 1450 may be physically integrated on the motherboard of computer 1420, and may be a software program, such as soft DSL, or the like.

In various embodiments, computer system 1400 may also include software that enables communications over a network such as the HTTP, TCP/IP, RTP/RTSP protocols, and the like. In alternative embodiments of the present invention, other communications software and transfer protocols may also be used, for example IPX, UDP or the like.

In some embodiment, computer 1420 includes one or more Xeon microprocessors from Intel as processor(s) 1460. Further, one embodiment, computer 1420 includes a UNIX-based operating system.

RAM 1470 and disk drive 1480 are examples of tangible media configured to store data such as embodiments of the present invention, including executable computer code, human readable code, or the like. Other types of tangible media include floppy disks, removable hard disks, optical storage media such as CD-ROMS, DVDs and bar codes, semiconductor memories such as flash memories, read-only-memories (ROMS), battery-backed volatile memories, networked storage devices, and the like. RAM 1470 and disk drive 1480 may be configured to store the basic programming and data constructs that provide the functionality of the present invention.

Software code modules and instructions that provide the functionality of the present invention may be stored in RAM 1470 and disk drive 1480. These software modules may be executed by processor(s) 1460. RAM 1470 and disk drive 1480 may also provide a repository for storing data used in accordance with the present invention.

RAM 1470 and disk drive 1480 may include a number of memories including a main random access memory (RAM) for storage of instructions and data during program execution and a read only memory (ROM) in which fixed instructions are stored. RAM 1470 and disk drive 1480 may include a file storage subsystem providing persistent (non-volatile) storage for program and data files. RAM 1470 and disk drive 1480 may also include removable storage systems, such as removable flash memory.

Bus subsystem 1490 provides a mechanism for letting the various components and subsystems of computer 1420 communicate with each other as intended. Although bus subsystem 1490 is shown schematically as a single bus, alternative embodiments of the bus subsystem may utilize multiple busses.

FIG. 14 is representative of a computer system capable of embodying the present invention. It will be readily apparent to one of ordinary skill in the art that many other hardware and software configurations are suitable for use with the present invention. For example, the computer may be a desktop, portable, rack-mounted or tablet configuration. Additionally, the computer may be a series of networked computers. Further, the use of other micro processors are contemplated, such as Pentium™ or Itanium™ microprocessors; Opteron™ or AthlonXP™ microprocessors from Advanced Micro Devices, Inc; and the like. Further, other types of operating systems are contemplated, such as Windows®, WindowsXP®, WindowsNT®, or the like from Microsoft Corporation, Solaris from Sun Microsystems, LINUX, UNIX, and the like. In still other embodiments, the techniques described above may be implemented upon a chip or an auxiliary processing board.

The specification and drawings are, accordingly, to be regarded in an illustrative rather than a restrictive sense. It will, however, be evident that various modifications and changes may be made thereunto without departing from the broader spirit and scope of the invention as set forth in the claims. In addition, the technique and system of the present invention is suitable for use with a wide variety of EDA tools and methodologies for programming a device. The scope of the invention should, therefore, be determined not with reference to the above description, but instead should be determined with reference to the pending claims along with their full scope or equivalents.

The present invention can be implemented in the form of control logic in software or hardware or a combination of both. The control logic may be stored in an information storage medium as a plurality of instructions adapted to direct an information-processing device to perform a set of steps disclosed in embodiments of the present invention. Based on the disclosure and teachings provided herein, a person of ordinary skill in the art will appreciate other ways and/or methods to implement the present invention.

The embodiments discussed herein are illustrative of one or more examples of the present invention. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the scope of the present invention. Hence, the present descriptions and drawings should not be considered in a limiting sense, as it is understood that the present invention is in no way limited to only the embodiments illustrated.

The above description is illustrative but not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A method for designing integrated circuits, the method comprising:
receiving a floorplan design associated with an integrated circuit;
extracting a first relative floorplanning constraint from the floorplan design; and
updating the floorplan of the integrated circuit in response to the first relative floorplanning constraint.

2. The method of claim 1 further comprising:
receiving a second relative floorplanning constraint; and
updating the floorplan of the integrated circuit in response to the second relative floorplanning constraint.

3. The method of claim 2 further comprising:
modifying the second relative floorplanning constraint based on the first relative floorplanning constraint; and
updating the floorplan of the integrated circuit in response to the modified second relative floorplanning constraint.

4. The method of claim 1 further comprising:
identifying a type associated with the first relative floorplanning constraint; and
generating a constraint graph based on the type, wherein an edge between a first node and a second node of the graph represents the first relative floorplanning constraint between a first object and a second object.

5. The method of claim 1 further comprising:
determining the integrity of the first relative floorplanning constraint.

6. A method for designing integrated circuits, the method comprising:
receiving a floorplan design associated with an integrated circuit;
receiving a set of relative floorplanning constraints from the floorplan design;
pushing down a relative floorplanning constraint from the set of relative floorplanning constraints into a partition associated with the floorplan of the integrated circuit; and
updating the floorplan in response to the set of relative floorplanning constraints.

7. The method of claim 6 wherein pushing down the relative floorplanning constraint from the set of relative floorplanning constraints comprises pushing down a relative floorplanning constraint that only is a segment portion of one of the set of relative floorplanning constraints.

8. The method of claim 6 further comprising:
performing floorplanning on the partition into which the relative floorplanning constraint was pushed down.

9. The method of claim 6 wherein pushing down the relative floorplanning constraint comprises:
identifying a relative floorplanning constraint that crosses one or more partition boundaries;
segmenting the relative floorplanning constraint into at least a first constraint and a second constraint; and
associating the first constraint with a first partition boundary and the second constraint with a second partition boundary.

10. The method of claim 1 wherein the relative floorplanning constraint relates to a location of an object.

11. The method of claim 10 wherein the location of the object is determined using a soft-macro edge-labeling scheme.

12. The method of claim 1 wherein the relative floorplanning constraint relates to rotation of an object.

13. The method of claim 1 wherein the relative floorplanning constraint relates to sizing of an object.

14. A computer program product stored on a computer readable medium for designing integrated circuits, the computer program product comprising:
code for receiving a floorplan design associated with an integrated circuit;
code for extracting a first relative floorplanning constraint from the floorplan design; and
code for updating the floorplan of the integrated circuit in response to the first relative floorplanning constraint.

15. The computer program product of claim 14 further comprising:
code for receiving a second relative floorplanning constraint; and
code for updating the floorplan of the integrated circuit in response to the second relative floorplanning constraint.

16. The computer program product of claim 15 further comprising:
code for modifying the second relative floorplanning constraint based on the first relative floorplanning constraint; and
code for updating the floorplan of the integrated circuit in response to the modified second relative floorplanning constraint.

17. The computer program product of claim 14 further comprising:
code for identifying a type associated with the first relative floorplanning constraint; and
code for generating a constraint graph based on the type, wherein an edge between a first node and a second node of the graph represents the first relative floorplanning constraint between a first object and a second object.

18. The computer program product of claim 14 further comprising:
code for determining the integrity of the first relative floorplanning constraint.

19. A computer program product stored on a computer readable medium for designing integrated circuits, the computer program product comprising:
code for receiving a floorplan design associated with an integrated circuit;
code for receiving a set of relative floorplanning constraints from the floorplan design;
code for pushing down a relative floorplanning constraint from the set of relative floorplanning constraints into a partition associated with the floorplan of the integrated circuit; and
code for updating the floorplan in response to the set of relative floorplanning constraints.

20. The computer program product of claim 19 wherein the code for pushing down the relative floorplanning constraint from the set of relative floorplanning constraints comprises code for pushing down a relative floorplanning constraint that only is a segment portion of one of the set of relative floorplanning constraints.

21. The computer program product of claim 19 further comprising:
code for performing floorplanning on the partition into which the relative floorplanning constraint was pushed down.

22. The computer program product of claim 19 wherein the code for pushing down the relative floorplanning constraint comprises:
code for identifying a relative floorplanning constraint that crosses one or more partition boundaries;
code for segmenting the relative floorplanning constraint into at least a first constraint and a second constraint; and
code for associating the first constraint with a first partition boundary and the second constraint with a second partition boundary.

23. A system for designing integrated circuits, the system comprising:
a processor; and
a memory coupled to the processor, the memory configured to store a plurality of code modules which when executed by the processor cause the processor to:
receive a floorplan design associated with an integrated circuit;
extract a first relative floorplanning constraint from the floorplan design; and
update the floorplan of the integrated circuit in response to the first relative floorplanning constraint.

24. The system of claim 23 wherein the processor is further caused to:
receive a second relative floorplanning constraint; and
update the floorplan of the integrated circuit in response to the second relative floorplanning constraint.

25. The system of claim 24 wherein the processor is further caused to:
modify the second relative floorplanning constraint based on the first relative floorplanning constraint; and
update the floorplan of the integrated circuit in response to the modified second relative floorplanning constraint.

26. A system for designing integrated circuits, the system comprising:
a processor; and
a memory coupled to the processor, the memory configured to store a plurality of code modules which when executed by the processor cause the processor to:
receive a floorplan design associated with an integrated circuit;
receive a set of relative floorplanning constraints from the floorplan design;
push down a relative floorplanning constraint from the set of relative floorplanning constraints into a partition associated with the floorplan of the integrated circuit; and
update the floorplan in response to the set of relative floorplanning constraints.

27. The system of claim 26 wherein the processor is further caused to:
push down a relative floorplanning constraint that only is a segment portion of one of the set of relative floorplanning constraints to push down the relative floorplanning constraint from the set of relative floorplanning constraints.

28. The system of claim 26 wherein the processor is further caused to:
perform floorplanning on the partition into which the relative floorplanning constraint was pushed down.

29. The system of claim 26 wherein the processor is further caused to:
identify a relative floorplanning constraint that crosses one or more partition boundaries;
segment the relative floorplanning constraint into at least a first constraint and a second constraint; and
associate the first constraint with a first partition boundary and the second constraint with a second partition boundary to push down the relative floorplannng constraint.
